(19) United States
(12) Patent Application Publication
(10) Pub. No.: US 2011/0221329 A1
(43) Pub. Date: Sep. 15, 2011

(54) Low Pressure Discharge Lamp

(76) Inventors: Achim Hilscher, Friedberg (DE); Armin Konrad, Grossaitingen (DE)

(21) Appl. No.: 13/127,236

(22) PCT Filed: Oct. 29, 2009
(86) PCT No.: PCT/EP2009/064253

§ 371 Date: May 2, 2011

(30) Foreign Application Priority Data
Oct. 31, 2008 (DE) 10 2008 054 175.3

(51) Int. Cl. H01J 61/44; H01J 61/76

(52) U.S. Cl. 313/487; 313/486

(57) ABSTRACT

A low-pressure discharge lamp having a discharge vessel which delimits a gas-tight fill chamber containing a filling gas, wherein the side of the discharge vessel facing the fill chamber is coated at least partially with a luminescent phosphor mixture by means of which electromagnetic radiation in the non-visible range can be transferred into the visible range. A low-pressure discharge lamp which is energy-saving and at the same time possesses good efficiency is provided in that primarily argon is used as the filling gas and that the average particle size of the luminescent phosphor mixture is greater than 5 m.

### TECHNICAL FIELD

The present invention relates to a low-pressure discharge lamp having a discharge vessel which delimits a gas-tight fill chamber containing a filling gas, wherein the side of the discharge vessel facing the fill chamber is coated at least partially with a luminescent phosphor mixture by means of which electromagnetic radiation from the non-visible range can be transferred into the visible range.

### PRIOR ART

Such low-pressure discharge lamps are widely established and are used in a multiplicity of applications, for example as fluorescent tubes or compact fluorescent lamps, which are frequently referred to also as energy-saving lamps.

### SUMMARY OF THE INVENTION

The object of the present invention is to provide a low-pressure discharge lamp which is energy-saving and at the same time possesses good efficiency.

This object is achieved by means of a low-pressure discharge lamp having the features recited in claim 1.

Advantageous developments of the invention are disclosed in the dependent claims.

A low-pressure discharge lamp according to the invention has a discharge vessel which delimits a gas-tight fill chamber containing a filling gas. The side of the discharge vessel facing the fill chamber is coated at least partially with a luminescent phosphor mixture by means of which electromagnetic radiation can be transferred from the non-visible range into the visible range. The phosphor mixture can be for example what is referred to as a triband mixture. The description triband mixture means that the emission spectrum of the phosphors used is matched to the sensitivity of the human eye such that an optimal color stimulus is achieved. The eye has three color receptors that possess relatively narrow sensitivity maxima in the red, green and blue spectral regions and must be stimulated in the optimum way. This is achieved in the case of triband mixtures in that the phosphors used have very narrow emission bands whose peak wavelengths ideally lie in the range of the respective sensitivity maxima of the eye. With the aid of triband technology the three spectral sensitivity ranges of the eye are therefore optimally stimulated by means of narrowband-emitting phosphors. The sensation of brightness and hence the light-emitting efficiency are therefore particularly high. In this case a number of emission bands can be present per sensitivity maximum of the eye.

The low-pressure discharge lamp can have at least one base having electrical contact elements, wherein the discharge vessel and the base are connected to each other as a single piece.

In general, a low-pressure discharge lamp according to the invention can have a base having electrical contact elements and a screening element which is translucent at least in sections and delimits the low-pressure discharge lamp in at least one spatial direction, the screening element and the base being connected to each other as a single piece and delimiting a gas-tight fill chamber containing a filling gas. Preferably the screening element can be embodied in the form of a discharge vessel. The side of the screening element facing the fill chamber is coated at least partially with a luminescent phosphor mixture by means of which electromagnetic radiation can be transferred from the non-visible range into the visible range.

According to the invention, argon is primarily provided as the filling gas for the low-pressure discharge lamp and the luminescent phosphor mixture has an increased yield in particular in the green spectral region.

By means of the inventive embodiment of the low-pressure discharge lamp it can advantageously be ensured that on the one hand the lamp voltage decreases, because the filling gas contains little or no neon in addition to argon. Krypton, for example, can also be mixed with the argon. This reduces the energy consumption of the low-pressure discharge lamp compared to conventional low-pressure discharge lamps. At the same time it effects a decrease in the operating temperature of the low-pressure discharge lamp, as a result of which the lighting current temperature curve shifts toward higher temperatures. This means that the low-pressure discharge lamp according to the invention can still be operated advantageously at higher ambient temperatures as well and there is an improvement in the relative light-emitting efficiency.

Simultaneously providing a luminescent phosphor mixture with an increased yield in the green spectral region enables the efficiency of the low-pressure discharge lamp according to the invention to be increased further, with the result that essentially the same lighting current can be realized by means of a correspondingly embodied low-pressure discharge lamp in comparison with a conventional one.

According to the invention, the luminescent phosphor mixture which is composed of individual phosphors is relatively coarse-grained, with an average particle size greater than or equal to 5 μm and preferably less than 20 μm, which means that the efficiency of the low-pressure discharge lamp according to the invention can be increased still further. The particle size can be determined by means of a measuring instrument known per se, for example from the company CILAS, and preferably according to the laser granulometry method. By choosing the appropriate particle size it is possible to increase the efficiency of the luminescent phosphor mixture further, since by this means light-scattering and reflection losses can be reduced in the discharge vessel.

According to a preferred development of the invention the luminescent phosphor mixture can contain cerium- and terbium-doped lanthanum phosphate (LaPO4:Ce, Tb) emitting in the green spectral region. In this case the peak wavelength is around 544 nm. The doping is chosen in particular such that the phosphor can be described by the chemical composition La_{(1-x-y)}PO₄:Ceₓ, Tb_{y}, where 0.25<=x<=0.38 and 0.18<=y<=0.25. In this case the doping specifications relate to the material quantity of said phosphor. In this case y is preferably greater than 0.2. By using said highly doped phosphor in the green spectral region, which, out of the luminescent phosphor mixture used, is preferably the only phosphor emitting in the green spectral region it is advantageously possible to influence the lighting current yield of the low-pressure discharge lamp according to the invention.

Particularly preferably, the average particle size of the cerium- and terbium-doped lanthanum phosphate is greater than or equal to 5 μm. At the same time the average particle size is preferably less than 20 μm. The particle size and the distribution width can be determined for example by means of a measuring instrument known per se, e.g. from the company CILAS, preferably according to the laser granulometry method. By choosing the appropriate particle size it is possible to increase the efficiency of the phosphor further, since light-scattering and reflection losses can be reduced in this way.

Preferably, the luminescent phosphor mixture of a low-pressure discharge lamp according to the invention can contain europium-doped barium magnesium aluminate (BaMgAl₁₀O₁₇:Eu) emitting in the blue spectral region, the doping being chosen in particular such that the chemical composition is given by Ba₍₁₋ₓ₎MgAl₁₀O₁₇:Euₓ, where 0.10<=x<=0.15. In this case the doping specifications relate to the material quantity of said phosphor. The peak wavelength of said phosphor is at 448 nm.

The luminescent phosphor mixture can also contain europium- and manganese-doped barium magnesium aluminate (BaMgAl₁₀O₁₇:Eu,Mn) emitting in the blue spectral region, the doping being chosen in particular such that the chemical composition is given by Ba₍₁₋ₓ₎Mg_{(1-y)}Al₁₀O₁₇:Euₓ,Mn_{y}, where 0.10<=x<=0.15 and 0.01<=y<=0.2. This enables the color rendering to be improved further, since as a result of the Mn doping a second emission maximum in the blue spectral region at approx. 515+/−3 nm is generated in addition to the emission maximum at approx. 451+/−3 nm.

The luminescent phosphor mixture can contain europium-doped yttrium oxide (Y₂O₃:Eu) emitting in the red spectral region. In this case the chemical composition is given in particular by Y₍₂₋ₓ₎O₃:Euₓ, where 0.07<=x<=0.15. In this case the doping specifications relate to the material quantity of said phosphor. The peak wavelength of said phosphor is at 611 nm.

According to an advantageous development of the inventive low-pressure discharge lamp, the average particle size of the europium-doped barium magnesium aluminate can be greater than or equal to 6.5 μm. Advantageously, the average particle size of the europium-doped yttrium oxide can be greater than or equal to 5 μm. Preferably, the average particle size for the two phosphors is less than or equal to 20 μm. In this case the particle size and the distribution width can be determined for example by means of the laser granulometry method.

Providing such highly doped phosphors has proved particularly advantageous because by this means the quantum efficiency of the luminescent phosphor mixture can be increased. The quantum efficiency of the luminescent phosphor mixture is the probability that for one absorbed photon from the UV region, one photon will be emitted in the visible spectral region. In the increase in the lighting current yield this increased quantum efficiency interacts particularly advantageously with the reduction in light-scattering and reflection losses achieved through the choice of particle size.

Preferably, europium-doped barium magnesium aluminate, europium-doped yttrium oxide and cerium- and terbium-doped lanthanum phosphate are used in particular jointly in the luminescent phosphor mixture of a low-pressure discharge lamp according to the invention. In particular they can be provided in the form of what is termed a triband mixture. Examples of mixing ratios for such triband mixtures are 77.4% Y₂O₃:Eu, 22.6% LaPO₄:Ce, Tb and 0% BaMgAl₁₀O₁₇:Eu; 69.0% Y₂O₃:Eu, 29.2% LaPO₄:Ce, Tb and 1.8% BaMgAl₁₀O₁₇:Eu; or 51.5% Y₂O₃:Eu, 39.2% LaPO₄:Ce, Tb and 9.27% BaMgAl₁₀O₁₇:Eu, wherein the tolerance range of the mixing ratios amounts to 3% of the specified quantities and the mixing ratios are specified in percent by weight. A triband mixture is also present in the case of a mixture having essentially only two phosphors, Y₂O₃:Eu in the red spectral region and LaPO₄:Ce, Tb in the green spectral region. The blue spectral region is provided in this case by the visible mercury radiation.

A low-pressure discharge lamp according to the invention can advantageously be embodied in such a way that the luminescent phosphor mixture includes a binding agent having a particle size lying in particular in the range from 50-200 m²/g. The mass fraction of the binding agent referred to the total phosphor mass can preferably lie in the range from 0.5 to 5% by weight and particularly preferably amount to between 0.75 and 1.0% by weight. An aluminum oxide, for example Aeroxide AluC from Evonik, formerly Degussa, or another gamma aluminum oxide having a specific surface area in the range from 50-200 m²/g can advantageously be used as the binding agent.

According to a preferred embodiment variant, the low-pressure discharge lamp according to the invention can contain 100% argon as the filling gas. In this way it can be ensured that the lamp voltage decreases further, in particular in comparison with similar existing lamps, since the filling gas contains no neon. The energy consumption of the low-pressure discharge lamp drops by about 10% compared with conventional low-pressure discharge lamps. As a result of the further decrease this produces in the operating temperature of the low-pressure discharge lamp, the lighting current temperature curve shifts toward higher temperatures. This means that the low-pressure discharge lamp according to the invention can still be operated advantageously at higher ambient temperatures as well and there is an improvement in the relative lighting current yield. By providing argon as the sole filling gas it is advantageously possible in addition to influence the cold start behavior of the low-pressure discharge lamp according to the invention. This has a particularly favorable effect at ambient temperatures of the lamp beneath 20° C.

A low-pressure discharge lamp according to the invention can be embodied particularly advantageously in such a way that a protective layer, in particular consisting of aluminum oxide, is applied on the side of the discharge vessel facing the fill chamber. Said protective layer is applied to the discharge vessel before it is coated with the luminescent phosphor mixture. The diffusion of mercury into the material of the discharge vessel, generally glass, can be reduced by means of said protective layer. In the case of the discharge vessel the inside of the discharge vessel is therefore coated first with the protective layer and then with the luminescent phosphor mixture. The application of such a protective layer is well-known, the thickness of the applied protective layer preferably lying in the range from 50-500 nm. The protective layer preferably comprises a mixture of aluminum oxide and rare-earth ions such as yttrium (Y), gadolinium (Gd), lanthanum (La) or barium (Ba). Aeroxide AluC from Evonik, formerly Degussa, can be used for this purpose, for example.

According to an advantageous development of the low-pressure discharge lamp according to the invention, the average layer weight of the coating of the discharge vessel as a result of the luminescent phosphor mixture can be greater than or equal to 4.3 mg/cm². Further preferably, the average layer weight of the coating of the discharge vessel as a result of the luminescent phosphor mixture can be less than or equal to 5.5 mg/cm². By this means it can be ensured that photons in the UV region are absorbed completely in the phosphor layer. The percentage of UV photons transmitted through the phosphor layer which is absorbed in the glass without emitting radiation can be reduced by this means.

The low-pressure discharge lamp according to the invention can have just one base and in particular belong to the group of so-called compact lamps in which a tube with sealed ends which is coated with phosphor and filled with filling gas forms the discharge vessel and is shaped in such a way that its two ends are mounted on a single base. Alternatively, however, a low-pressure discharge lamp according to the invention can also be provided with two bases, in particular also in the form of a fluorescent tube. It is advantageous in the case of both embodiments that during the manufacture of a low-pressure discharge lamp according to the invention only the type of filling gas and the luminescent phosphor mixture need to be changed and otherwise the production line can remain unchanged. Simple and cost-effective production can therefore be guaranteed. This furthermore enables the low-pressure discharge lamp according to the invention to be used as what is termed a retrofit. This means that the low-pressure discharge lamp can be inserted into existing lampholders without further modification measures. Existing lighting installations can therefore be operated easily with low-pressure discharge lamps according to the invention, enabling power savings to be achieved while at the same time the lighting current remains essentially unchanged.

Advantageously, the base can be implemented as a known and essentially standardized base, thereby further simplifying the extensive application potential of the low-pressure discharge lamp according to the invention.

According to a further advantageous embodiment of the invention, the low-pressure discharge lamp is embodied for operation with a conventional ballast. This enables the inventive advantages to be realized particularly easily during operation, since with conventional ballasts there is no regulation of the current or voltage to ensure that these are kept constant. The effect of the lamp voltage reduction through the use of essentially argon as the filling gas can therefore be particularly well exploited, since it leads to no significant change and in particular only to such a negligible increase in the discharge current that the power draw of the low-pressure discharge lamp falls. In this case the base of the low-pressure discharge lamp according to the invention can have in particular two contact pins as electrical contact elements for operation by means of the conventional ballast.

Alternatively the low-pressure discharge lamp according to the invention can also be embodied for operation with an electronic ballast, the latter preferably regulating the current constantly, since this allows the power savings to be realized particularly easily without simultaneously increasing the discharge current in the low-pressure discharge lamp.

### PREFERRED EMBODIMENT OF THE INVENTION

The invention shall be explained in more detail below with reference to a preferred exemplary embodiment.

Toward that end, low-pressure discharge lamps known per se of the compact fluorescent lamp shape, in the present example of the type DULUX D 18 W and DULUX D 26 W from the company OSRAM GmbH, with unchanged geometry and same base, were modified for testing purposes in the respect that 100% argon was used as the filling gas. The phosphor coating was also changed and was composed of a luminescent phosphor mixture consisting of the following phosphors: LaPO₄:Ce,Tb, Y₂O₃:Eu and BaMgAlₙ:Eu, and specifically in the following mixture ratio: 51.5% Y₂O₃:Eu, 39.2% LaPO₄:Ce, Tb and 9.27% BaMgAl₁₀O₁₇:Eu, the tolerance range amounting to 3% of the specified quantities.

In this case the phosphors had the chemical composition of Ba_{0.9}MgAl₁₀O₁₇:Eu_{0.1}, La_{0.4}PO₄:Ce_{0.4}, Tb_{0.2} and Y_{1.93}O3:Eu_{0.07}.

The average layer weight of the luminescent phosphor mixture amounted to approx. 5.1 mg/cm² referred to the coated surface area. The inventively modified lamps were provided with the additional acronym ES (for Energy Saver).

When operated with a conventional ballast it was demonstrated that in comparison with the conventional DULUX D lamps the lamps achieved a power saving in the region of 10%. Thus, the modified lamp corresponding to the DULUX D 18 W could essentially be operated at 16 W, while the modified lamp corresponding to the DULUX D 26 W could essentially be operated at 23 W.

The test conditions and the measurement results achieved are summarized in the following Table 1.

TABLE 1

| | DULUX D 16W ES | DULUX D 23W ES |
|---|---|---|
| Geometry same as | DULUX D 18W | DULUX D 26W |
| U_{Lp} [V] | 85 | 90 |
| I_{Lp} [mA] | 235 | 340 |
| P_{Lp} [W] | 16 | 24 |
| Filling gas | 100% argon | 100% argon |
| Fill pressure [Pa] | 600 | 600 |
| Green phosphor | LaPO₄:Ce, Tb | LaPO₄:Ce, Tb |
| Layer weight [g/lamp] | 0.31 | 0.36 |
| φ (25° C.) [lm] | 1120 | 1700 |
| φ (25° C.) [lm] | 1040 | 1570 |

Measurements were also carried out on low-pressure discharge lamps supplemented with the suffix ES that were modified as described above and comparative lamps DULUX D in which the lighting current was measured as a function of the ambient temperature of the lamp. The results are summarized in Table 2. It will be clear that the lighting current lies in the same range both for the comparative lamps and for the inventive low-pressure discharge lamp of lower power draw.

TABLE 2

| | Lighting current [lm] | | | |
|---|---|---|---|---|
| | DULUX D | DULUX D | DULUX D | DULUX D |
| ° C. | 18W | 16W ES | 26W | 23W ES |
| 25 | 1185 | 1148 | 1808 | 1700 |
| 30 | 1154 | 1107 | 1710 | 1652 |
| 35 | 1081 | 1075 | 1608 | 1570 |
| 50 | 882 | 897 | 1325 | 1331 |

Further measurements were carried out in a typical lighting fixture with the low-pressure discharge lamp arranged horizontally at an ambient temperature of the lighting fixture of 25° C. Table 3 shows the corresponding results.

TABLE 3

| | DULUX D | DULUX D | DULUX D | DULUX D |
|---|---|---|---|---|
| | 18W | 16W ES | 26W | 23W ES |
| φ (25° C.) [lm] | 1128 | 1082 | 1626 | 1585 |
| P_{Lamp} [W] | 17.3 | 15.0 | 27.4 | 24.3 |
| η_{Lamp} [lm/W] | 65.2 | 72.1 | 59.3 | 65.2 |

A notable aspect in this regard is the particularly good efficiency η_{Lamp} of the low-pressure discharge lamps according to the invention in relation to the comparative lamps.

It can clearly be seen that a significant reduction in the power draw at the same time as a high lighting current yield can be realized by means of low-pressure discharge lamps according to the invention.

It is to be assumed that when the transition to series production is made still further improvements can be achieved, since then inconsistencies during manufacture, in particular in the coating process, can be substantially avoided.

Thus, it has been successfully demonstrated that significant power savings at high lighting current can be achieved using low-pressure discharge lamps according to the invention. This can made possible according to the invention in particular through the use of a modified filling gas and a phosphor having a high yield in the green spectral region. Preferably highly doped, coarse-grained phosphors can be used in this case.

1. A low-pressure discharge lamp comprising a discharge vessel which delimits a gas-tight fill chamber containing a filling gas, wherein the side of the discharge vessel facing the fill chamber is coated at least partially with a luminescent phosphor mixture with which electromagnetic radiation in the non-visible range can be transferred into the visible range,
wherein
argon is primarily provided as the filling gas and the average particle size of the luminescent phosphor mixture is greater than 5 m.

2. The low-pressure discharge lamp as claimed in claim 1, wherein
the luminescent phosphor mixture contains cerium- and terbium-doped lanthanum phosphate emitting in the green spectral region, the doping being chosen in particular such that the chemical composition is given by La_{(1-x-y)}PO₄:Ceₓ, Tb_{y}, where 0.25<=x<=0.38 and 0.18<=y<=0.25.

3. The low-pressure discharge lamp as claimed in claim 2, wherein
the average particle size of the cerium- and terbium-doped lanthanum phosphate is greater than 5 m.

4. The low-pressure discharge lamp as claimed in claim 1, wherein
the luminescent phosphor mixture contains europium-doped barium magnesium aluminate emitting in the blue spectral region, the doping being chosen in particular such that the chemical composition is given by Ba₍₁₋ₓ₎MgAl₁₀O₁₇:Euₓ, where 0.10<=x<=0.15, and/or contains europium-doped yttrium oxide emitting in the red spectral region, the doping being given in particular by Y₍₂₋ₓ₎O3:Euₓ, where 0.07<=x<=0.15.

5. The low-pressure discharge lamp as claimed in claim 1, wherein
the luminescent phosphor mixture contains europium- and manganese-doped barium magnesium aluminate emitting in the blue spectral region, the doping being chosen in particular such that the chemical composition is given by Ba₍₁₋ₓ₎Mg_{(1-y)}Al₁₀O₁₇:Euₓ,Mn_{y}, where 0.10<=x<=0.15 and 0.01<=y<=0.2.

6. The low-pressure discharge lamp as claimed in claim 4, wherein
the average particle size of the europium-doped barium magnesium aluminate is greater than or equal to 6.5 m and/or the average particle size of the europium-doped Yttrium oxide is greater than or equal to 5 m.

7. The low-pressure discharge lamp as claimed in claim 1, wherein
the luminescent phosphor mixture includes a binding agent whose mass fraction referred to the total phosphor mass lies in the range from 0.5 to 5% by weight.

8. The low-pressure discharge lamp as claimed in claim 1, wherein
100% argon is provided as the filling gas.

9. The low-pressure discharge lamp as claimed in claim 1, wherein
the average layer weight of the coating of the discharge vessel as a result of the luminescent phosphor mixture is greater than or equal to 4.3 mg/cm².

10. The low-pressure discharge lamp as claimed in claim 1, wherein
it is embodied for operation with a conventional ballast.

11. The low-pressure discharge lamp as claimed in claim 1, wherein
it is configured for operation with an electronic ballast.
